(19) United States
(12) Patent Application Publication
(10) Pub. No.: US 2026/0232502 A1
(43) Pub. Date: Aug. 13, 2026

(54) DOCKING DEVICE FOR WHEELCHAIRS

(71) Applicant: MASKINFABRIK DAHL ENGINEERING APS, Thisted (DK)

(72) Inventor: Claus Dahl Pedersen, Thisted (DK)

(21) Appl. No.: 19/156,958

(22) PCT Filed: Jan. 19, 2024
(86) PCT No.: PCT/EP2024/051211

§ 371 Date: Aug. 15, 2025

(30) Foreign Application Priority Data
Feb. 28, 2023 (DK) PA202300184

(51) Int. Cl. A61G 3/08

(52) U.S. Cl. CPC A61G 3/0808

(57) ABSTRACT

A docking device is shown for being mounted on, preferably beneath, a wheelchair and adapted for releasably securing a wheelchair to the floor of a transport vehicle. The docking device includes a) a base unit; b) fastening means adapted for securing the docking device to, preferably beneath, the wheelchair, the fastening means being mounted on the base unit; c) a first female or male docking fixture adapted for locking engagement with a second male or female docking fixture mounted to the floor of a transport vehicle, the docking fixture being directly or indirectly mounted to the base unit; d) a first leveling mechanism adapted for displacing the first docking fixture up and down relative to the base unit; and e) a second leveling mechanism adapted for tilting the first docking fixture relative to the base unit.

### TECHNICAL FIELD OF THE INVENTION

The present invention relates to transportation of wheelchair users, and more particularly to means adapted to secure the wheelchair into a transport vehicle.

### BACKGROUND OF THE INVENTION

The welfare and safety of persons being transported in wheelchairs is of ever-increasing concern, and many jurisdictions have enacted stringent safety requirements for devices to secure the wheelchair into the transport vehicle and the occupant into the wheelchair. Numerous solutions, most of which are reasonably effective, have been suggested in the prior art, but they frequently require the attachment of a plurality of straps or the like to one or more anchor points in the transport vehicle. After attachment, the straps must be tightened either by the wheelchair occupant or by an attendant. There have been some attempts to provide self-attachment devices in the past and attention is directed to U.S. Pat. No. 7,229,238 in which a locking mechanism is secured beneath a wheelchair and releasably locked to a docking station similarly mounted under the wheelchair, on the floor of the vehicle. While reasonably effective in certain circumstances, it does not solve the problem that wheelchairs are constructed differently, and that the distance between the locking mechanism secured beneath the wheelchair and the docking station thus will vary. Hence, such a solution is impractical for transport vehicles used for public service, or for service of different passengers in general. Furthermore, it does not take into account that a wheelchair chassis is often adjusted, e.g., up, down, or tilted, thereby changing the position of the docking fixture mounted thereon.

WO2018184884 discloses a height adjustable wheelchair docking system adapted for releasably securing a wheelchair to the floor of a transport vehicle comprising: a) a base frame with an open end, and adapted for rigid attachment to the floor of a transport vehicle; b) a middle frame adapted for sliding back and forth in a horizontal direction within the base frame and through the open end; c) means configured to slide the middle frame in relation to the base frame; and d) a top frame adapted for covering at least a part of the base frame and middle frame, and adapted to move up and down in a vertical direction in relation to the base frame when the middle frame is sliding back and forth in a horizontal direction within the base frame and through the open end. The top frame further comprises a female or male docking fixture adapted for locking engagement with a male or female docking fixture on a wheelchair.

In particular, there is a need for a docking fixture for securement beneath a wheelchair that can be used with many types and sizes of wheelchairs.

### SUMMARY OF THE INVENTION

A first aspect relates to a docking device for being mounted on, preferably beneath, a wheelchair and adapted for releasably securing a wheelchair to the floor of a transport vehicle, said docking device comprising:
a base unit;
fastening means adapted for securing the docking device to, preferably beneath, the wheelchair, said fastening means being mounted on said base unit;
a first female or male docking fixture adapted for locking engagement with a second male or female docking fixture mounted to the floor of a transport vehicle, said docking fixture being directly or indirectly mounted to said base unit;
a first leveling mechanism adapted for displacing said first docking fixture up and down relative to said base unit; and
a second leveling mechanism adapted for tilting said first docking fixture relative to said base unit.

A second aspect relates to a docking system for releasably securing a wheelchair to the floor of a transport vehicle, said system comprising:
a docking device according to the present invention; and
a second male or female docking fixture adapted for being mounted to the floor of the transport vehicle, and adapted for engaging with the first female or male docking fixture of said docking device.

The fastening means may have many different configurations, such as clamps mounted or bolted to the base unit and adapted for clamping onto parts of the wheelchair, such as to the chassis. In some embodiments, the fastening means are adapted for releasably fastening to a wheelchair. The fastening means may comprise brackets, such a pair of Y-shaped or C-shaped fork brackets, adapted for being mounted at the front end of the wheelchair, and a pair of locking pins adapted for engaging with said brackets, wherein the brackets are mounted on the base unit. In some embodiments, the fastening means may comprise a pair of clamps adapted for being mounted at the rear end of the wheelchair and mounted on the base unit. The pair of clamps are preferably adapted for engaging or clamping onto the rear wheel axle of a wheelchair. Alternatively, the pair of clamps may be part of an axle system providing rigidity to e.g., a foldable wheelchair, such that it will not fold when mounted to the floor of a transport vehicle.

The docking device is preferably U-shaped or tubular. This is to provide space for tools to handle (tighten or loosen) bolt nuts or screws mounted or being part of the docking device when adjustments are needed.

The base unit may have many different configurations. Some of its functions are to provide support for other parts, such as the fastening means, and the docking fixture, and for taking part in adjustment features. When the docking device is U-shaped or tubular, the base unit may be embodied as two opposite plate parts that may be opposite wall parts of a tubular or U-shaped structure. When the opposite plate parts are separate plates, the fastening means and the male docking fixture may aid in stabilizing this construct.

In one or more embodiments, the docking device further comprises an adapter unit mounted to the base unit, and wherein the docking fixture is mounted to said adapter unit. Preferably, the adapter unit is configured for regulating the distance between the base unit and the docking fixture, e.g., simply functioning as an extension part. The docking device may comprise a kit of different heights of adapter units.

In one or more embodiments, the docking device further comprises an adapter unit mounted to the base unit; wherein the docking fixture is mounted to the adapter unit; and wherein said adapter unit is configured for regulating the docking fixture's position in the vertical direction (in a use situation).

The adapter unit may also comprise means adapted for mechanically regulating the distance between the base unit and the docking fixture, or for regulating the docking fixture's position in the vertical direction (in a use situation). That could e.g., be a rack and pinion solution, where the base unit and the docking fixture can be moved together, or simply by providing multiple bolt or pin holes along the height and optionally length (in use) of the adapter unit as different mounting positions for both the base unit and the docking fixture.

In one or more embodiments, the adapter unit comprises a plurality of pin holes or bolt holes adapted for use in regulating the distance between the base unit and the docking fixture.

It may also be necessary to regulate the docking fixture's horizontal position relative to the base unit, e.g., if the docking fixture would otherwise extend beyond the front of the wheelchair. In one or more embodiments, the adapter unit comprises a plurality of guide recesses, and wherein the base unit comprises one or more guide pins (e.g., guide pins releasably mounted thereto, such as configured as bolts, e.g., with corresponding nuts). Preferably, the guide recesses and guide pins are adapted for use in regulating the docking fixture's horizontal position relative to the base unit and/or relative to the wheelchair on which the docking device is mounted.

In one or more embodiments, the second leveling mechanism is configured as one or more guide recesses formed in the base unit and one or more guide pins (e.g., guide pins releasably mounted thereto, such as configured as bolts, e.g., with corresponding nuts) fastened to the adapter unit and each adapted for moving within their respective guide recess.

In one or more embodiments, the guide pins (e.g., guide pins releasably mounted thereto, such as configured as bolts, e.g., with corresponding nuts) adapted for use in regulating the docking fixture's horizontal position relative to said base unit are also used as part of the second leveling mechanism.

In one or more embodiments, the docking device further comprises a third leveling mechanism adapted for tilting the first docking fixture relative to the adapter unit. As a preferred example, third leveling mechanism may be configured as one or more guide recesses formed in the first docking fixture and one or more guide pins (e.g., guide pins releasably mounted thereto, such as configured as bolts, e.g., with corresponding nuts) mounted on the adapter unit and each adapted for moving within their respective guide recess.

In one or more embodiments, the one or more guide pins are configured as releasably fastened bolts, e.g., with corresponding nuts.

In some embodiments, the adapter unit may not be present as an extension of that amount is not necessary. In this case, the second leveling mechanism may be configured as one or more guide recesses formed in the base unit and one or more guide pins (e.g., guide pins releasably mounted thereto, such as configured as bolts, e.g., with corresponding nuts) mounted on the docking fixture and each adapted for moving within their respective guide recess.

The first female or male docking fixture may have many different configurations e.g., depending on the configuration of the second male or female docking fixture mounted to the floor of the transport vehicle. The docking fixture may e.g., be a male docking fixture, and e.g., comprise an upper portion (in use), a middle-positioned neck portion, and a lower positioned head portion. In order to induce mechanical strength into the docking fixture, the upper portion (in use) may be configured with a bottom plate (in use) with walls (e.g., two opposite side walls, and two opposite end walls, in use) optionally extending upwards therefrom. The walls, preferably the side walls, may be provided with the above disclosed bolt holes and/or guide recesses formed in the docking fixture.

A third aspect relates to a docking device for being mounted on, preferably beneath, a wheelchair and adapted for releasably securing a wheelchair to the floor of a transport vehicle, said docking device comprising:
a base unit;
fastening means adapted for securing the docking device to, preferably beneath, the wheelchair, said fastening means being mounted on said base unit;
a first female or male docking fixture adapted for locking engagement with a second male or female docking fixture mounted to the floor of a transport vehicle, said docking fixture being directly or indirectly mounted to said base unit; and
an adapter unit mounted to the base unit, and wherein the docking fixture is mounted to said adapter unit;
optionally a first leveling mechanism adapted for displacing said first docking fixture up and down relative to said base unit; and
optionally a second leveling mechanism adapted for tilting said first docking fixture relative to said base unit.

Preferably, the adapter unit is configured for regulating the distance between the base unit and the docking fixture, e.g., simply functioning as an extension part. The docking device may comprise a kit of different heights of adapter units. The adapter unit may independently of the other functions also serve as a support for e.g., a motor either aiding in displacing the first docking fixture up and down relative to the base unit, or aiding in driving or operating the wheelchair.

Another aspect relates to a docking device for being mounted on a wheelchair and adapted for releasably securing a wheelchair to the floor of a transport vehicle, said docking device comprising:
a base unit;
fastening means adapted for securing the docking device to the wheelchair, said fastening means being adapted for being mounted on said base unit; and
a first female or male docking fixture adapted for locking engagement with a second male or female docking fixture mounted to the floor of a transport vehicle, said first docking fixture being adapted for being directly or indirectly mounted to said base unit;
a first leveling mechanism adapted for displacing said first docking fixture up and down relative to said base unit; and
a second leveling mechanism adapted for tilting said first docking fixture relative to said base unit.

In one or more embodiments, the docking device further comprises an adapter unit adjustable mounted to said base unit; wherein said docking fixture is mounted to said adapter unit; and wherein said adapter unit is configured for regulating the vertical distance, preferably as an up and down movement, between said base unit and said docking fixture, preferably thereby providing multiple selectable distances between said base unit and said docking fixture.

In one or more embodiments, the adapter unit comprises a plurality of pin holes or bolt holes adapted for use in regulating the vertical distance, preferably as an up and down movement, between said base unit and said docking fixture.

In one or more embodiments, the adapter unit comprises a plurality of guide recesses, and wherein said base unit comprises one or more guide pins, said guide recesses and guide pin(s) adapted for use in regulating the docking fixture's horizontal position, preferably as a back-and-forth movement, relative to said base unit.

In one or more embodiments, the adapter unit comprises a plurality of guide recesses, and wherein said base unit comprises one or more guide pins, said guide recesses and guide pin(s) adapted for use in regulating the docking fixture's horizontal position, preferably as a back and forth movement, relative to said base unit; wherein the second leveling mechanism is configured as one or more guide recesses formed in the base unit and one or more guide pins fastened to the adapter unit and each adapted for moving within their respective guide recess; and wherein the guide pins adapted for use in regulating the docking fixture's horizontal position relative to said base unit are also used as part of the second leveling mechanism.

In one or more embodiments, the base unit is configured as two opposite plate parts.

In one or more embodiments, the fastening means, and the male docking fixture is adapted for stabilizing/supporting said two opposite plate parts.

In one or more embodiments, each plate part comprises a flange adapted as support for mounting the fastening means thereto.

In one or more embodiments, the flange comprises elongate bolt holes for use in mounting the fastening means, thereby allowing the position of the fastening means to be adjusted along the length of said flange.

In one or more embodiments, the base unit further comprises an extension bracket adapted for being mounted at different positions along the length of the plate parts.

In one or more embodiments, the base unit further comprises an extension bracket adapted for being mounted at different positions along the length of the flange of the plate parts.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

### BRIEF DESCRIPTION OF THE FIGURES

FIG. 1 shows a docking device in accordance with various embodiments of the invention mounted on a wheelchair (only a part of the wheelchair is shown).

FIG. 2 shows a perspective view of a docking device in accordance with various embodiments of the invention.

FIG. 3 shows a perspective view of a base unit in accordance with various embodiments of the invention.

FIG. 4 shows a perspective view of a part of a docking device in accordance with various embodiments of the invention.

FIG. 5 shows a perspective view of an adapter unit in accordance with various embodiments of the invention.

FIG. 6 a perspective view of a first docking fixture in accordance with various embodiments of the invention.

### DETAILED DESCRIPTION OF THE INVENTION

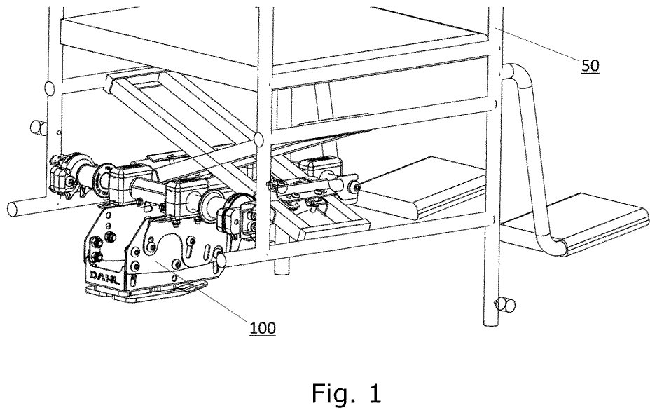

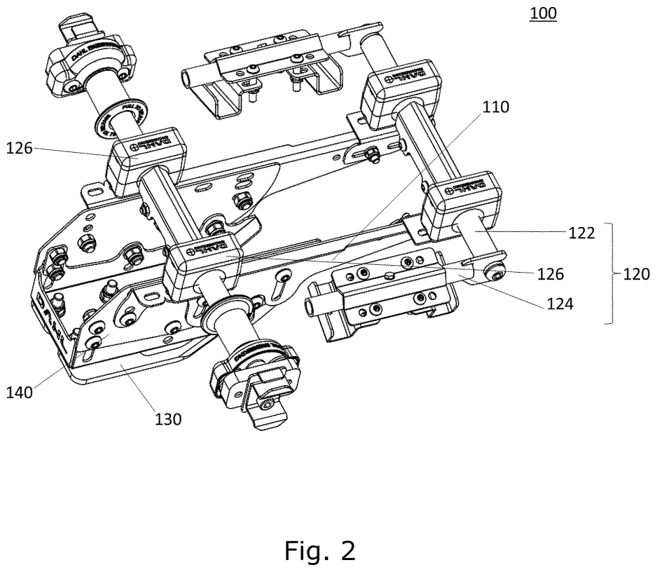

Referring to FIG. 1, the general scheme of the invention is shown. FIG. 1 shows a docking device 100 mounted on a wheelchair 50 and adapted for releasably securing the wheelchair 50 to the floor of a transport vehicle (not shown). The docking device 100 comprises (see FIG. 2) a base unit 110, fastening means 120 adapted for securing the docking device 100 (here specifically the base unit 110) to the wheelchair 50, a male docking fixture 130 adapted for locking engagement with a second female docking fixture (not shown) mounted to the floor of the transport vehicle, and an adapter unit 140 mounted to the base unit 110. The male docking fixture 130 is indirectly mounted to the base unit 110 via the adapter unit 140.

The fastening means 120 may have many different configurations and will not be dealt with in detail. The shown configuration is adapted for releasably fastening to a foldable wheelchair, where at the front end of the wheelchair 50 a pair of Y-shaped fork brackets 124 are mounted, and a pair of locking rods 122 adapted for engaging with said fork brackets 124 are mounted on the base unit 110. At the rear end of the wheelchair 50, a pair of clamps 126 mounted on the base unit 110 may engage with the rear wheel axle of the wheelchair. Alternatively, the pair of clamps 126 may be part of an axle system (as shown) providing rigidity to the foldable wheelchair 50 such that it will not fold when mounted to the floor of a transport vehicle. Hence, the docking device 100 may be used with both un-foldable and foldable wheelchairs. When used with the rear wheel axle of a wheelchair, the clamps 126 may be provided with a kit of inserts, each adapted for a specific diameter and shape of a rear wheel axle.

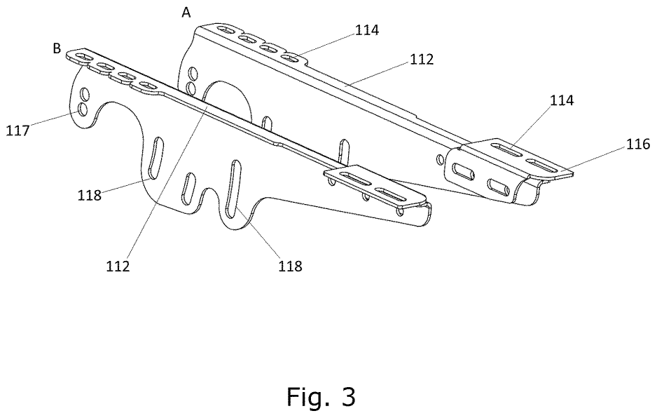

The base unit 110 is here embodied as two opposite plate parts A, B, as seen in FIG. 3. The fastening means 120 and the male docking fixture 130 aids in stabilizing this construct (see FIG. 2). Now turning to FIG. 3, each plate part A, B comprises a flange 112 adapted as support for mounting the fastening means 120 thereto. The flange is also shown with elongate bolt holes 114 for use with the fastening means. The bolt holes are elongate to provide room for the base unit 110 and fastening means 120 to fit with wheelchairs with different types of chassis. In some embodiments, and as shown here, the flange 112 may be provided with an extension bracket 116 that is adapted for being mounted at different positions along the length of the plate part A, B and flange 112. As its name implies, the extension bracket 116 is used as an extension of the plate part A, B but may in some embodiments just be used as part of the flange 112, as e.g., shown in FIG. 3. This configuration also allows the male docking fixture 130 to be positioned further to the rear end of the wheelchair 50.

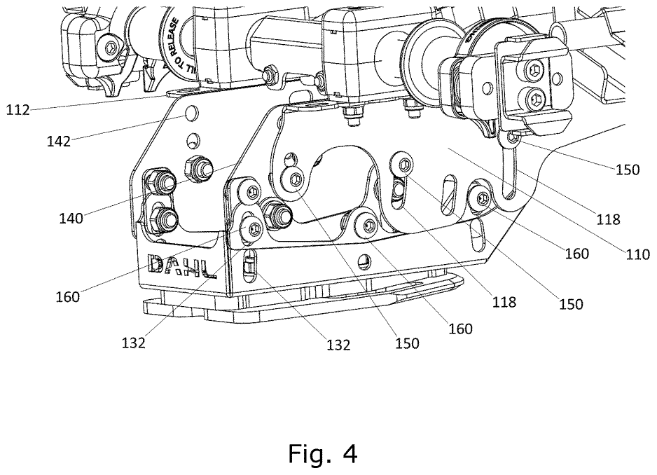

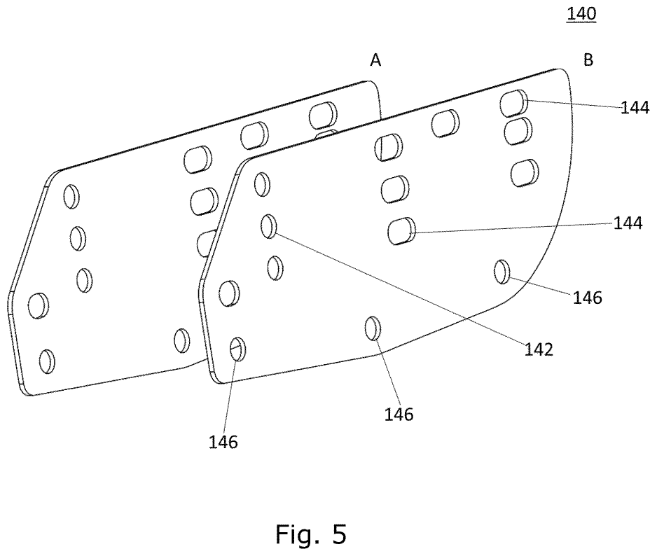

The docking fixture 130 is shown mounted to the adapter unit 140 (see FIG. 4) and is configured for regulating the distance between the base unit 110 and the docking fixture 130. The adapter unit 140 is here embodied as two opposite plate parts A, B, as seen in FIG. 5. The adapter unit 140, i.e., each plate part A, B, comprises a plurality of bolt holes 142, 144 adapted for use in regulating the distance between the base unit 110 and the docking fixture 130. The bolt holes 142, 144 are used to bolt the base unit 110 to the adapter unit 140 via appropriate bolt holes 117, 118 in the former, and bolts 150. Furthermore, the bolt holes 144 are also configured as guide recesses, which together with appropriate bolt holes 118 in the base unit, and bolts 150 may be used in a minor regulation of the docking fixture's 130 horizontal position relative to the base unit 110. In FIG. 4, one of the plate parts (the one in the front of the figure) is shown transparent to better understand how the different components are positioned in relation to each other.

The docking device 100 comprises a leveling mechanism adapted for tilting the first docking fixture 130 relative to the base unit 110. A part of the leveling mechanism is integrated in the base unit 110 as arc-shaped guide recesses 118 in each plate part A, B, also functioning as bolt holes as disclosed above, which together with appropriate bolt holes 144 in the adapter unit 140, and bolts 150 makes it possible to tilt the first docking fixture 130 relative to the base unit 110. Here, the bolt 150 functions as guide pins moving within the guide recess. Another part of the leveling mechanism is the already disclosed bolt hole 117 in each plate part A, B integrated into the base unit 110, which together with appropriate bolt holes 142 in the adapter unit 140, and bolts 150 functions as a pivoting axis about which the first docking fixture 130 is able to tilt relative to the base unit 110.

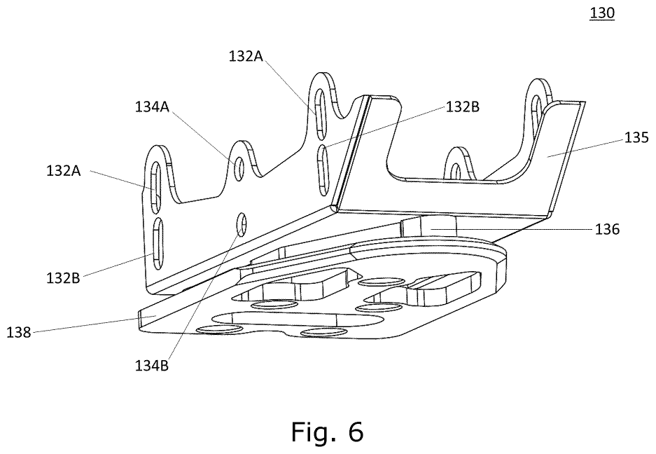

The docking fixture 130 could have many different configurations but is here shown with an upper portion 135, a middle-positioned neck portion 136, and a lower positioned head portion 138 (see FIG. 6).

The docking fixture 130 is shown mounted to the adapter unit 140 with bolts 160 (see FIG. 4) via bolt holes 132, 134 formed in the docking fixture 130 (see FIGS. 4 and 6), and bolt holes 146 formed in the adapter unit 140 (see FIG. 5). A special embodiment is shown in the figures where three bolt holes 132, 134 are formed on each side of the docking fixture 130. The middle bolt hole 134 is circular, while the front and rear bolt holes 132 are arc shaped. This configuration allows the docking fixture 130 to tilt around an axis passing through the pair of middle bolt holes 134, relative to the adapter unit 140, and hence also relative to the base unit 110. As can be seen in FIG. 6, a two sets of bolt holes are formed, an upper set 132A, 134A, and a lower set 132B, 134B. This embodiment allows for a further vertical adjustment of the head portion 138 (together with the rest of the docking fixture 130).

The docking device 100 is U-shaped or tubular. This is to provide space for tools to handle (tighten or loosen) the bolt nuts when adjustments are needed.

### REFERENCES

50 Wheelchair
100 Docking device
110 Base unit
112 Flange
114 Bolt hole
116 Extension bracket
117 Bolt hole
118 Guide recess and bolt hole
120 Fastening means
122 Locking rods
124 Y-shaped fork bracket
126 Clamp
130 First docking fixture
132 Guide recess
134 Bolt hole
135 Upper portion
136 Neck portion
138 Head portion
140 Adapter unit
142 Bolt hole
144 Guide recess
150 Bolt-shaped guide pin
160 Bolt-shaped guide pin

1. A docking device (100) for mounting on a wheelchair (50) and for releasably securing a wheelchair to a floor of a transport vehicle, said docking device (100) comprising:
a base unit (110);
fastening means (120) adapted for securing the docking device (100) to the wheelchair (50), said fastening means (120) for mounting on said base unit (110); and
a first female or male docking fixture (130) for locking engagement with a second male or female docking fixture mounted to the floor of a transport vehicle, said first docking fixture (130) for direct or indirect mounting to said base unit (110);
a second leveling mechanism for tilting said first docking fixture (130) relative to said base unit (110);
wherein the docking device (100) further comprises:
a first leveling mechanism for displacing said first docking fixture (130) up and down relative to said base unit (110).

2. The docking device (100) according to claim 1, further comprising an adapter unit (140) adjustably mounted to said base unit (110); wherein said docking fixture (130) is mounted to said adapter unit (140); and wherein said adapter unit (140) is configured for regulating a vertical distance, preferably as an up and down movement, between said base unit (110) and said docking fixture (130), thereby providing multiple selectable distances between said base unit (110) and said docking fixture (130).

3. The docking device (100) according to claim 2, wherein the adapter unit (140) comprises a plurality of pin holes or bolt holes (142, 144) adapted for use in regulating the vertical distance, between said base unit (110) and said docking fixture (130).

4. The docking device (100) according to claim 2, wherein the adapter unit comprises a plurality of guide recesses (144), and wherein said base unit (110) comprises one or more guide pins (150), said guide recesses (144) and said one or more guide pins (150) adapted for use in regulating a horizontal position of said docking fixture (130), as a back and forth movement, relative to said base unit (110).

5. The docking device (100) according to claim 2, wherein the second leveling mechanism is configured as one or more guide recesses (118) formed in the base unit (110) and one or more guide pins (150) fastened to the adapter unit (140) and each configured for moving within their respective guide recess (118).

6. The docking device (100) according to claim 3, wherein the adapter unit (140) comprises a plurality of guide recesses (144), and wherein said base unit (110) comprises one or more guide pins (150), said guide recesses (144) and guide pin(s) (150) for use in regulating a horizontal position of said docking fixture (130) as a back and forth movement, relative to said base unit (110); wherein the second leveling mechanism is configured as one or more guide recesses (118) formed in the base unit (110) and one or more guide pins (150) fastened to the adapter unit (140) and each adapted for moving within a respective guide recess (118) of the one or more guide recesses; and wherein the guide pins (150) adapted for use in regulating the horizontal position of the docking fixture relative to said base unit (110) are also used as part of the second leveling mechanism.

7. The docking device (100) according to claim 1, wherein the second leveling mechanism is configured as one or more guide recesses (118) formed in the base unit (110) and one or more guide pins mounted on the docking fixture (130) and each configured for moving within their respective guide recess (118).

8. The docking device (100) according to claim 2, further comprising a third leveling mechanism adapted for tilting said first docking fixture (130) relative to said adapter unit (140).

9. The docking device (100) according to claim 8, wherein the third leveling mechanism is configured as one or more guide recesses (132) formed in the first docking fixture (130) and one or more guide pins (160) mounted on the adapter unit (140) and each configured for moving within their respective guide recess (132).

10. The docking device (100) according to claim 4, wherein the one or more guide pins (150, 160) are configured as releasably fastened bolts.

11. The docking device (100) according to claim 1, said docking device (100) being U-shaped or tubular.

12. The docking device (100) according to claim 1, wherein the base unit 110 is configured as two opposite plate parts (110A, B).

13. The docking device (100) according to claim 12, wherein the fastening means (120) and the male docking fixture (130) are configured for stabilizing/supporting said two opposite plate parts (110A, B).

14. The docking device (100) according to claim 12, wherein each plate part (110A, B) comprises a flange (112) configured as a support for mounting the fastening means (120) thereto.

15. The docking device (100) according to claim 14, wherein the flange (112) comprises elongate bolt holes (114) for use in mounting the fastening means (120), thereby allowing the position of the fastening means (120) to be adjusted along the length of said flange (112).

16. The docking device (100) according to claim 12, wherein the base unit (110) further comprises an extension bracket (116) for mounting at different positions along the length of the plate parts (110A, B).

17. The docking device (100) according to claim 12, wherein the base unit (110) further comprises an extension bracket (116) for mounting at different positions along the length of the flange (112) of the plate parts (110A, B).

18. A docking system for releasably securing a wheelchair to the floor of a transport vehicle, said system comprising:
a docking device (100) according to claim 1; and
a second male or female docking fixture for mounting to the floor of the transport vehicle, and for engaging with the first female or male docking fixture (130) of said docking device (100).
